(19) United States
(12) Patent Application Publication
(10) Pub. No.: US 2005/0238319 A1
(43) Pub. Date: Oct. 27, 2005

(54) Recordable player with external storage device

(75) Inventors: Ching-Hai Chen, Taipei (TW); Ching-Ho Huang, Taipei (TW)

Correspondence Address: BACON & THOMAS, PLLC, 625 SLATERS LANE, FOURTH FLOOR, ALEXANDRIA, VA, 22314, US

(73) Assignee: LITE-ON IT CORPORATION, Taipei (TW)

(21) Appl. No.: 11/107,856

(22) Filed: Apr. 18, 2005

(30) Foreign Application Priority Data
Apr. 21, 2004 (TW) 93111044

(51) Int. Cl. H04N 5/781

(52) U.S. Cl. 386/46; 386/125

(57) ABSTRACT

A recordable player has an external storage device to advantageously extend the capacity, facilitate the portability and provide the aseismatic design. The external storage device is additionally connected to a DVD or VCD recordable player. A USB transmission port or an IEEE 1394 transmission port is embedded in the DVD or VCD recordable player. Thus, data transmission between the player and the external storage device may be made through a USB transmission line or an IEEE 1394 transmission line. Therefore, AV data can be transferred to the external storage device from the DVD or VCD recordable player such that the AV data can be edited, rewritten and deleted. In addition, the data in the external storage device also can be transferred back to the DVD recordable player so that the data can be recorded and played.

This application claims the benefit of Taiwan application Serial No. 93111044, filed Apr. 21, 2004, the subject matter of which is incorporated herein by reference.

### BACKGROUND OF THE INVENTION

1. Field of the Invention

The invention relates in general to a recordable player with an external storage device, and more particularly to a DVD or VCD recordable player with an external storage device.

2. Description of the Related Art

Because the multimedia technology is highly developed, several AV (Audio-Video) products, such as a video tape, CD, VCD, DVD and the like, with the combined audio and video effects have become more popular. In general, the VCD and DVD can be played and recorded using the recordable player, such as a VCD recordable player or DVD recordable player, which pertains to the home AV product. Because the DVD recordable player can access the DVD with the data capacity of 4.7 GB (Gigabytes), it plays an important role among the home AV products. The description will be made with reference to the DVD recordable player.

FIG. 1 is a schematic illustration showing a conventional DVD recordable player. The DVD recordable player 110 includes an analog AV transmission port 130, such as an AV terminal, for receiving a television signal. The television signal can be a NTSC (National Television System Committee) or a PAL (Phase Alternation Line) signal. The player 110 processes the television signal by way of AV processing and then transfers the processed signal to a DVD recorder 120 of the DVD recordable player 110.

In general, the user can perform the function of recording the television signal by merely touching a REC key of the DVD recordable player 110. FIG. 2 is a block diagram showing a method for processing the AV data in a conventional DVD recordable player. The prior art DVD recordable player 200 includes a processor 210, an encoder 220, a decoder 230, a DVD recorder 240, a displayer 250, and an AV (Audio-Video) terminal cable 260. The processor 210, the encoder 220 and the decoder 230 form a control circuit. The AV terminal cable 260 is connected to the analog AV transmission port 130 of FIG. 1.

When the user selects to record the television signal transferred on the AV terminal cable 260, the processor 210 transfers the television signal received via the AV terminal cable 260 to the encoder 220, and the encoder 220 encodes the inputted television signal into a motion picture compression standard format, such as MPEG1, MPEG2 and MPEG4, to form an AV compressed data stream to be transferred to the DVD recorder 240. Finally, the DVD recorder 240 records the encoded AV compressed data stream on a DVD optical disk.

While the DVD recordable player is recording data, the AV terminal cable 260 can be directly connected to the displayer 250. As a result, the user can view the pictures on the displayer 250 while the pictures are being recorded. In addition, when the user-selects to play the AV compressed data stream in the DVD recorder 240, the processor 210 transfers the AV compressed data stream in the DVD recorder 240 to the decoder 230, and the decoder 230 decodes the inputted AV compressed data stream into a play signal to be inputted to the displayer 250.

In order to response to the coming of the digital television broadcast age, as shown in FIG. 1, the DVD recordable player 110 further includes a digital AV transmission port 140, such as a DV terminal, for receiving the digital signal of the current HDTV system.

FIG. 3 is a schematic illustration showing a build-in data storage device in a conventional DVD recordable player. The DVD recordable player 310 includes an analog AV transmission port 330, such as an AV (Audio-Video) terminal, for receiving a television signal. The television signal can be a NTSC (National Television System Committee) or PAL (Phase Alternation Line) signal.

The television signal may be processed into the AV data by way of the AV processing of FIG. 2. The user can transfer the AV data to a DVD recorder 320 in the DVD recordable player 310 so as to record the AV data. The AV data also may be transferred to a data storage device 350, such as a hard disk, so that the AV data can be edited, rewritten and deleted. Thus, the user can record the AV data while playing the AV data stored in the data storage device 350 so as to achieve the time-shifting function. In order to response to the coming of the digital television broadcast age, the DVD recordable player 310 further includes a digital AV transmission port 340, such as a DV terminal, for receiving the digital signal of the current HDTV system.

The time-shifting function means that the user can stop the playing of the AV data in the data storage device 350. During the stop, the DVD recorder 320 can continue recording the AV data. After the stop, the user can continue playing the AV data stored in the data storage device 350. FIG. 4 is a schematic illustration showing a time-shifting condition. The user can stop the playing at a break point 440 between the AV data 410 and the AV data 420. Then, the user can continue playing the AV data from the break point 440 so as to maintain the playing smoothness in the next play.

During the stop, the DVD recorder still keeps recording the AV data. Thus, when the user continues playing the AV data 420 from the break point 440, the AV data being recorded by the DVD recorder is at the recording point 450 between the AV data 420 and the AV data 430, and the so-called time-shifting function presents. Hence, even if the user stops playing the data in the middle of playing, the time-shifting function still enables the next section of the AV data 420 to be played by the user without influencing the recording operation during the stop.

However, the build-in data storage device tends to be shocked or knocked during the conveying process or the user tends to move the recordable player when he or she is using the device. So, the build-in data storage device tends to be easily damaged. More particularly, when the build-in data storage device is accessing data and is moved by the user or is slightly shocked, the build-in data storage device is damaged and cannot be used again, and the data stored in the build-in data storage device also may be damaged and cannot be accessed. In addition, because the build-in data storage device has the limited data storage capacity, the user data also may be lost when the received signal contains a lot of data exceeding the capacity of the build-in data storage device.

### SUMMARY OF THE INVENTION

It is therefore an object of the invention to provide a recordable player with an external storage device in order to eliminate the problem that the build-in data storage device tends to be damaged due to the collision or shock when the recordable player is being conveyed or carried by the user.

The invention achieves the above-identified object by providing a recordable player having an external storage device to advantageously extend the capacity, facilitate the portability and provide the aseismatic design. The external storage device is additionally connected to a DVD or VCD recordable player. A USB (Universal Serial Bus) transmission port or an IEEE 1394 transmission port is embedded in the DVD or VCD recordable player. Thus, the data transmission between the player and the external storage device may be made through a USB transmission line or an IEEE 1394 transmission line. Therefore, the AV data can be transferred to the external storage device from the DVD or VCD recordable player such that the AV (Audio-Video) data can be edited, rewritten and deleted. In addition, the data in the external storage device also can be transferred back to the DVD recordable player so that the data can be recorded and played.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a schematic illustration showing a conventional DVD recordable player.

FIG. 2 (Prior Art) is a block diagram showing a method for processing the AV data in a conventional DVD recordable player.

FIG. 3 (Prior Art) is a schematic illustration showing a build-in data storage device in a conventional DVD recordable player.

FIG. 4 (Prior Art) is a schematic illustration showing a time-shifting condition.

FIG. 5 is a schematic illustration showing a recordable player with an external storage device.

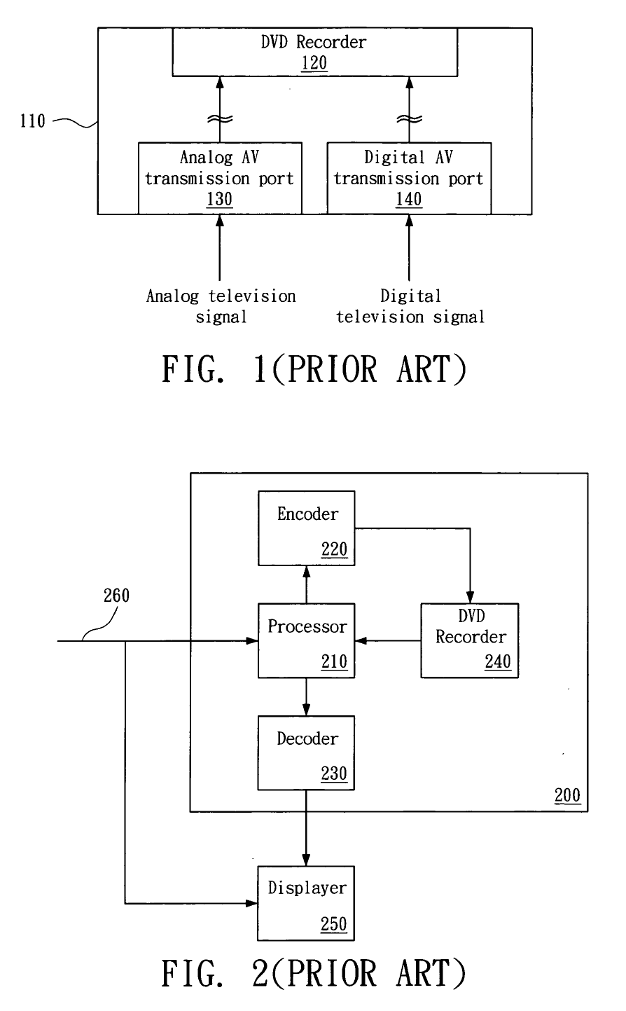

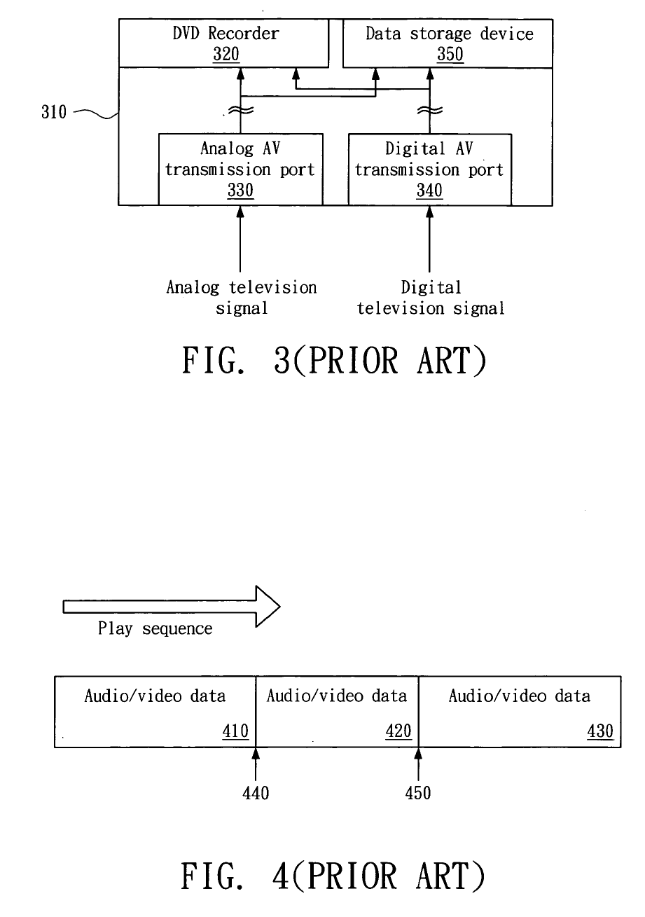

### DETAILED DESCRIPTION OF THE INVENTION

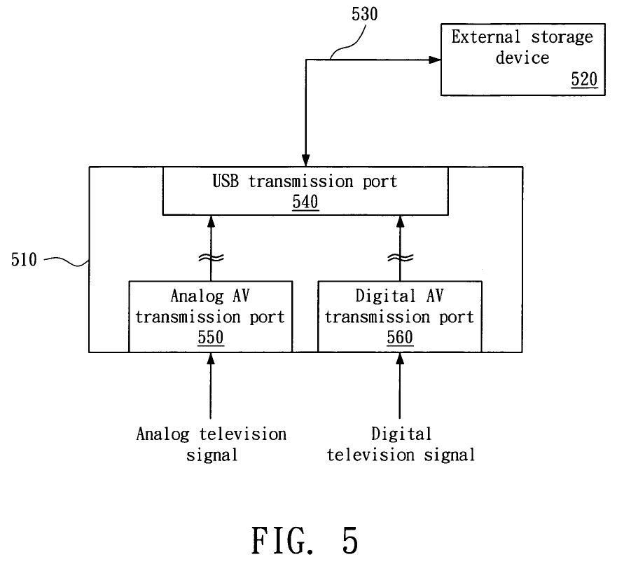

FIG. 5 is a schematic illustration showing a recordable player with an external storage device according to the invention. The recordable player includes a DVD recordable player 510, an external storage device 520, a USB (Universal Serial Bus) transmission line 530, a USB transmission port 540, an analog AV transmission port 550 and a digital AV transmission port 560. The DVD recordable player 510, the USB transmission port 540, the analog AV transmission port 550 and the digital AV transmission port 560 are disposed in a first casing, and the external storage device 520 is disposed in a second casing. As shown in FIG. 5, the external storage device 520 outside the DVD recordable player 510 is additionally added in this invention. The external storage device 520 is connected to the USB transmission port 540 of the DVD recordable player 510 through the USB transmission line 530.

The DVD recordable player 510 further includes the analog AV transmission port 550, such as AV (Audio-Video) terminal, for receiving a television signal. The television signal can be a NTSC (National Television System Committee) or a PAL (Phase Alternation Line) signal. The television signal is transferred to a control circuit, which processes the television signal into an AV compressed data stream and transfers the AV compressed data stream to the USB transmission port 540 or a DVD recorder of the DVD recordable player 510 so that the AV compressed data stream can be recorded. The user can execute the television recording function by merely pressing a REC key of the DVD recordable player 510. In order to response to the coming of the digital television broadcast age, the DVD recordable player 510 further includes the digital AV transmission port 560, such as a DV terminal, for receiving the digital signal of the current HDTV system.

In addition to the operation of transferring the AV data to the DVD recorder of the DVD recordable player 510 so as to record the AV compression data, the user can transfer the AV data from the DVD recordable player 510 to the external storage device 520 through the USB transmission line 530 and edit, rewrite, or delete the AV data. The user also can transfer the data in the external storage device 520 back to the DVD recordable player 510 to execute the recording function. Therefore, the user can record the television signal while playing the AV data stored in the external storage device 520 in a time-shifting manner.

The current external storage devices available in the market have the aseismatic design for resisting the shock, the good styling design, and the miniaturized volume for facilitating the portability. The invention is made by considering the external storage device, which is portable and has the extended capacity and can resist the shock. A USB or IEEE 1394 transmission port is added to the DVD recordable player such that the data transmission between the external storage device and the recordable player can be made via the USB transmission line or the IEEE 1394 transmission line. The capacity of the current external storage device has reached 300 GB, so the user can carry a lot of data by the external storage device.

Therefore, one advantage of the invention is to achieve the time-shifting function by adding an external storage device to a DVD recordable player.

Another advantage of the invention is to prevent the data storage device from being damaged due to the collision in the conveying procedure or the user's unintentional movement by adding an external storage device to a DVD recordable player.

Still another advantage of the invention is to prevent the data from being lost when the data quantity of the user is too large by extending the capacity of the data storage device.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A recordable player, comprising:
a first casing, in which a recorder, a first transmission port, a control circuit and a second transmission port are disposed, wherein the first transmission port receives a television signal and transfers the television signal to the control circuit, and the control circuit converts the television signal into an AV compressed data stream and transfers the AV compressed data stream to the second transmission port or the recorder; and
a second casing, in which an external storage device is disposed, wherein the external storage device accesses the AV compressed data stream through the second transmission port.

2. The player according to claim 1, wherein the first casing is a DVD recordable player or a VCD recordable player.

3. The player according to claim 1, wherein the first transmission port is an analog AV transmission port or a digital AV transmission port.

4. The player according to claim 1, wherein the control circuit comprises an encoder, a decoder and a processor.

5. The player according to claim 1, wherein the second transmission port is a USB transmission port or an IEEE 1394 transmission port.

6. The player according to claim 1, wherein the external storage device is an external hard disk.

7. A recordable player, comprising:
a recorder;
a first transmission port;
a control circuit;
a second transmission port; and
a data storage device,
wherein the recorder, the first transmission port, the control circuit and the second transmission port are disposed in a first casing, the first transmission port receives a television signal and transfers the television signal to the control circuit, and the control circuit converts the television signal into an AV compressed data stream and transfers the AV compressed data stream to the second transmission port or the recorder;
wherein the data storage device is disposed in a second casing and accesses the AV compressed data stream through the second transmission port; and
wherein data stored in the data storage device may also be transferred to the control circuit through the second transmission port.

8. The player according to claim 7, wherein the first casing is a DVD recordable player or a VCD recordable player.

9. The player according to claim 7, wherein the first transmission port is an analog AV transmission port or a digital AV transmission port.

10. The player according to claim 7, wherein the control circuit comprises an encoder, a decoder and a processor.

11. The player according to claim 7, wherein the second transmission port is a USB transmission port or an IEEE 1394 transmission port.

12. The player according to claim 7, wherein the data storage device is an external hard disk.
